(19) United States
(12) Patent Application Publication
(10) Pub. No.: US 2011/0035228 A1
(43) Pub. Date: Feb. 10, 2011

(54) QUANTIFIED SYSTEM TO DESIGN, PLAN AND MANAGE ORGANIZATIONS' SALES ACTIVITIES

(76) Inventors: Yingbo Li, Beijing (CN); Peng Sheng, Beijing (CN); Abdelazia Guergahi, Burlington (CA)

Correspondence Address: CHADBOURNE & PARKE LLP, 30 ROCKEFELLER PLAZA, NEW YORK, NY, 10112, US

(21) Appl. No.: 10/599,449

(22) PCT Filed: Mar. 29, 2005
(86) PCT No.: PCT/CN2005/000400

§ 371 Date: Jul. 9, 2008

(30) Foreign Application Priority Data
Mar. 29, 2004 (CN) 200410029832.2

(51) Int. Cl. G06Q 10/00

(52) U.S. Cl. 705/1.1

(57) ABSTRACT

A system, apparatus, and methods for facilitating a sales team to create, populate, and maintain a customer sales knowledgebase. The customer sales knowledgebase may be used to by sales people in developing a sales strategy, for example identifying key people within a customer entity for a particular sales pitch and determining how to approach key people. The knowledgebase may be utilized as a present transaction resource or for aggregating customer data for use by other members of a sales team. After sales people interact with key persons within the customer entity, the knowledgebase provides a common repository for sharing customer impression data, detailing which sales strategies were successful and to what extent the sales strategies were successful. Furthermore, the knowledgebase may also be used by corporate decision makers or sales managers for sales to facilitate sales forecasts and determine which customers to target.

### PRIORITY CLAIM/CROSS-REFERENCES TO RELATED APPLICATIONS

This application is a continuation in part of prior PCT Application No. PCT/CN2005/000400, filed Mar. 29, 2005, titled “Sale Processes Quantizing Management System”, as well as Chinese Application number 200410029832.2, filed Mar. 29, 2004 to all of which priority under 35 USC §§119, 365 and 371 is claimed. The entire contents the PCT and Chinese applications are herein expressly incorporated by reference.

### FIELD OF THE INVENTION

The present invention comprises a set of integrated techniques, workflows, procedures, business rules, algorithms and formulas to derive actionable information and deliver it electronically, in a computer distributed environment, to individual salespeople, sales managers and sales teams as a Customer Needs Management (CNM) system. This information allows them to effectively communicate and manage their customers' needs, and design and plan the sales activities within the selling organization. Also, according to an implementation of the invention, the modules developed in the present invention are built upon a single integrated framework.

### BACKGROUND OF THE INVENTION

Most organizations rely heavily either on the concepts of sales funnel or sales pipeline (which do not reflect the process of value formation and exchange on the part of customer), or on individual sales staff members (who use their individual experience and feelings) to construct an evaluation of the progress, impact and effectiveness of the sales activities concerning their target business transactions. This type of evaluation cannot ensure the alignment of the seller's interpretations with the customer buying logic, as it is inherently subjective and could be incorrect. Because of the complexity of most sales situations, the performance of a seller is determined to a great extent by the intrinsic quality of the framework he or she uses to interpret, communicate and handle sales situational factors. At the management level, there are currently no guidelines that allow the sales managers to objectively anchor their management activities onto the customer's cognition, psychology and behavior with regard to what this customer looks for in terms of value. Because of this, the performance of these sales managers and the instructions they provide to their sales staff members may end up being sub-optimal or even mediocre. The present invention has been made in consideration of the above points.

### BRIEF SUMMARY OF THE INVENTION

Accordingly, it is the purpose of the present invention to provide sales managers and salespeople with an objective and quantified system that focuses on the value formation and exchange processes from a customer's perspective and that will help them carry out the following tasks:
1—design the appropriate sales activities for customer needs management
2—monitor/evaluate/adjust the sales activities in order to boost up the business performance within the selling organization
3—the sales manager can evaluate the work done by the individual salespeople objectively, quantitatively and in real-time.
4—the sales manger can evaluate the progress status of the target business transactions, assess the probability of their success, and instruct the salespeople to help them improve their performance and the selling organization's performance reasonably and appropriately.
5—decision makers can generate reliable sales forecasts at any time expediently.

This objective and quantified system is consistent with a teamwork setting and is to be deployed in a standardized language, which not only enables less experienced salespeople to speed up their learning curves, but also empowers experienced salespeople to align their personal skills and endeavors with the process of value formation and exchange on the part of the customer. In addition, and most importantly, the system is based upon a single, integrated and comprehensive framework—the CNM (custom needs management) framework. This system will also be referred to as the CNM system.

### BRIEF DESCRIPTION OF THE DRAWINGS

FIG. 1 shows the abbreviations table of the specific concepts in the present invention;

FIG. 2 shows a block diagram that expresses the core logic of the business method—the CNM framework which underlies the present invention;

FIG. 3 shows a block diagram that expresses the concepts of Purchase Role and Key Persons;

FIG. 4 shows an example of conversion algorithm between Attitude Indicator and Confidence Indicator;

FIG. 5 shows the basic components of CNM pattern library;

FIG. 6 shows CNM user roles used in the present invention;

FIG. 7 shows the computer distributed environment in which the present invention may be used;

FIG. 8 shows the functional modules that the present invention uses according to an embodiment of the invention;

FIG. 9 shows a template for the sales success rate as a function of CI;

FIG. 10 shows an example of the CNM-VS version;

FIG. 11 shows an example of a sales process workflow;

FIG. 12 shows an example of another CNM-VS version;

FIG. 13 illustrates an implementation of a CNM controller according to an embodiment of the invention

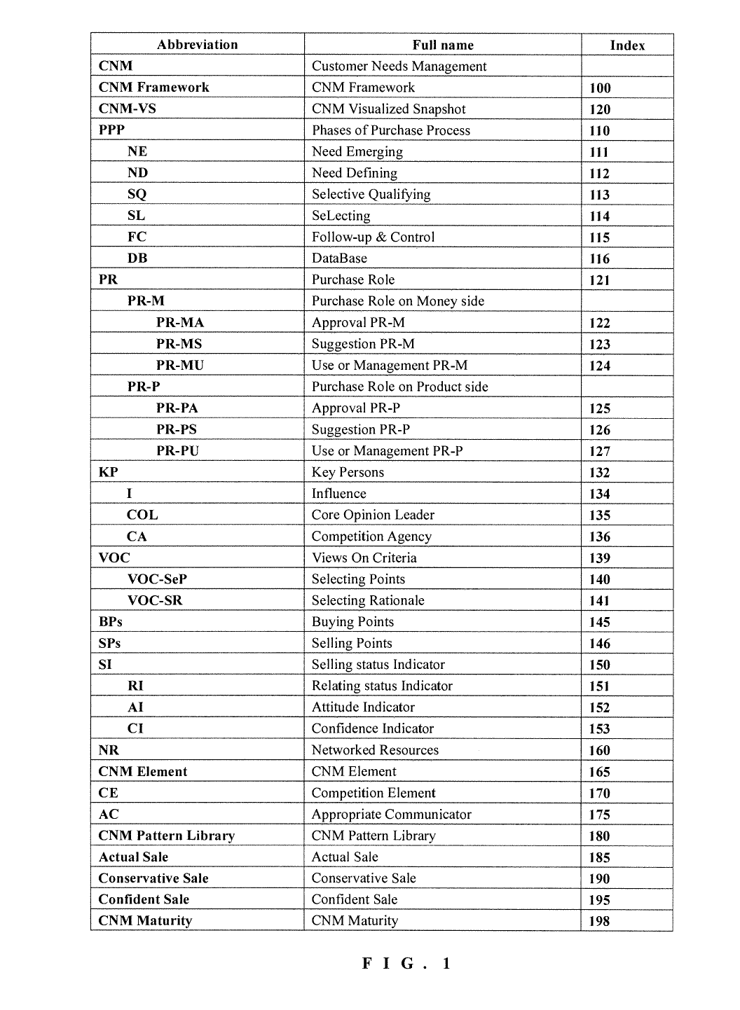

### DETAILED DESCRIPTION OF THE INVENTION

The Quantified System to Design, Plan and Manage Organizations' Sales Activities, which is the object of this invention, will now be explained. To do that, the basic building blocks and distinctive features of the system and its underlying CNM framework are described first. Then the system, its workflows and the way it can be deployed in an enterprise setting are explained by presenting a concrete example of its implementation.

System Overview

The disclosure describes aspects of a quantified system configured to design, develop and manage the sales activities of an organization intending to sell its products and/or services to another organization (customer). The system incorporates aspects of the scientific principle of parsimony, as it makes use of an inference structure that draws conclusions about selling, sales management and sales forecasting from analysis of several of key processes: the Phases of the Purchase Process, Key Persons and Purchase Roles, Views On Criteria, Buying Points and Selling Points, Selling status Indicator, Appropriate Communicator, and Networked Resources processes. These elements constitute the building blocks of the integrated Customer Needs Management (CNM) solution.

According to an embodiment of the invention, the workflows may be incorporated into a system and implemented as a computer-distributed environment comprised of user terminal devices for users' interaction with the system, where the terminal devices are configured to facilitate system logic servers for handling the business rules, the system logic and the calculations. Furthermore, the system includes system database servers for storing and handling data about the sales activities and about the cognition, attitudes and behaviors of customers. Advantageously, the user terminals may be distributed across a network, allowing the servers and terminals to communicate among each other, while situated either locally or remotely. The resulting CNM system computer-distributed environment facilitates an efficient open exchange of customer data among sales team members.

In an embodiment, the CNM system is implemented with systemization configured to execute a set of the CNM solution described below as workflows, and quantified procedures. The specification includes details describing how the CNM framework is implemented through computer systemization. The workflows according to an embodiment described herein are based in part on system user/customer interaction. For example, advantageously, data about the sales activities, the cognition, attitudes and behaviors of customers can be automatically and logically arranged into visualized snapshots of the actual sales process, and converted into quantified indices to be used for decision making the current and future sales process. These data are collected by the salespeople during sales events during interaction with the customer. The system users input the data into the computerized CNM system according to a set of workflows described herein.

According to an implementation of the invention, each sales event goes through two stages: design stage and implementation stage. Based on the previous/historical sales events, the existing information about the customer, and the CNM pattern library, a system user (e.g., the salesperson) designs the next sales event using the logic and workflows of the system. If the design is approved, the salesperson enters the implementation stage. Each stage has a number of steps, in which the salesperson needs to input related customer data into the system according to the CNM framework. Also, the system is able to provide the user with intelligent assistance as the system user interacts with the system's CNM framework and the system user interface.

Part of the framework and the system user interface includes a template, referred to as the CNM pattern library. The CNM pattern library allows sales people to capture data about their customers, their needs, views, attitudes and behaviors, as well as about the industries in which these customers operate. This template allows salespeople to build a significant knowledge base about their customers and their corresponding industries.

The system also includes a ‘quantitative management of sales process’ module which facilitates a sales events design process, a sales events implementation process, a sales management process, a sales support process. In an implementation of the system, the said sales events design process includes the steps:

(1) Identify organizational Phases of the Purchase Process (PPP): salesperson identifies organizational PPP according to CNM pattern library and traceable information.

(2) Identification of Key Persons: depending on the specific stage of organizational PPP in (1), salesperson finds and identifies the Key Persons, which can play one or many of six roles, have different influences, have different individual PPP, and includes Core Opinion Leader and Competition Agency.

(3) Pick up Views On Criteria: depending on the background information and the specific characteristics of Key Persons, Purchase Roles and PPP, the salesperson picks up Views On Criteria for Key Persons in (2).

(4) Design Buying Points and Selling Points: salesperson designs Buying Points and Selling Points for Key Persons, according to their Views On Criteria in (3).

(5) Obtain Selling status Indicators: salesperson designs how to get Selling status Indicators for Key Persons.

(6) Appropriate Communicator choice: salesperson chooses the Appropriate Communicator according to the previous steps, and communicates with him or her.

(7) Action plan: salesperson plans the action, and the related cost in terms of time and money.

(8) Assessment: evaluate the rationality and operability of the present sales event design. If a sales event design goes through the assessment, salesperson could start to implement the sales event according to the design.

Further, in addition to sales people using the system, sales managers and/or decision makers (e.g., corporate executives) may utilize the system in conducting sales forecasting, selling strategy development or internal team performance assessment. These types of analytical sales management and support processes and may be conducted based on analysis of a system user's, customer sales event design and implementation processes. The system may also be used by management to determine sales forecasts and/or assess the performance of members of the sales staff. Furthermore, the system may be configured with rules, definitions, algorithms and formulas to evaluate the following items based on the elements of the CNM framework:

(1) Integrated Selling status Indicators

(2) Sales forecasting parameters: conservative sale, confident sale, integrated sale forecast

(3) salespeople performance

(4) Sales success rate

Each of these analytical processes assist in facilitating an efficient, effective selling organization implementing its sales strategies as team based initiatives.

To describe the buying decision-making processes within an organization, the present invention introduces a universal model called the Phases of the Purchase Process (PPP) 110.

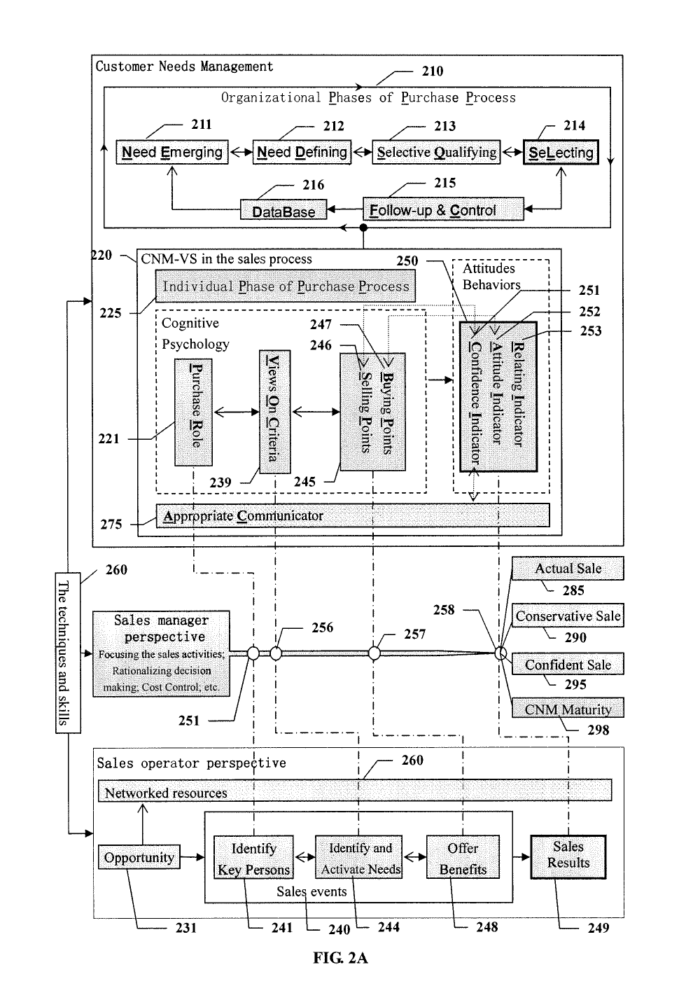

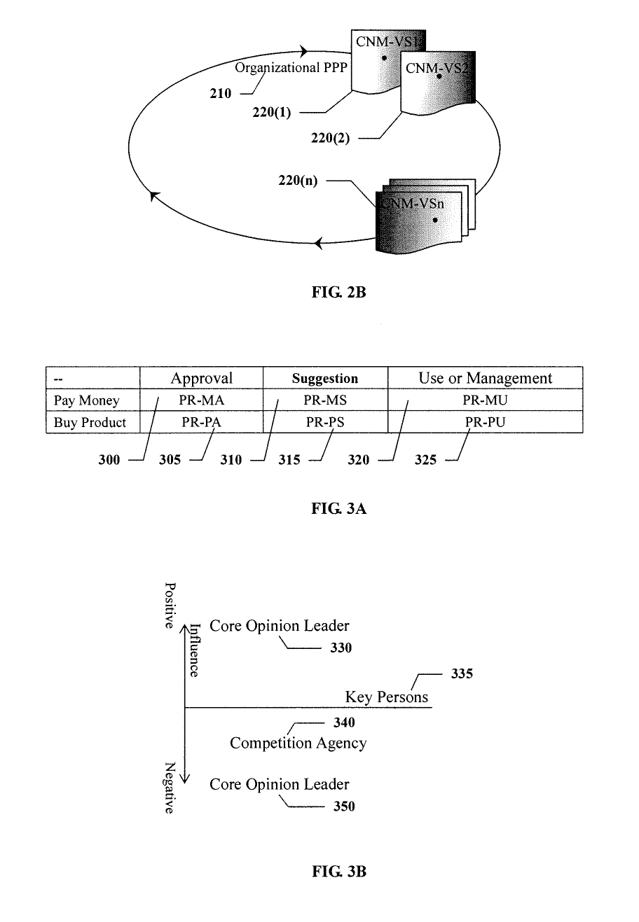

FIG. 2A shows the organizational PPP 210 and how each individual phase of it (Individual PPP 225) is to be analyzed by the seller using the various building blocks of invention. FIG. 2A also shows the core logic (i.e., the relationships among these building blocks) of the system, which is referred to here as the CNM framework 100. The PPP model includes six phases: Need Emerging (NE) 211, Need Defining (ND) 212, Selective Qualifying (SQ) 213, SeLecting (SL) 214, Follow-up and Control (FC) 215, and DateBase (DB) 216.

For the purposes of illustration, the various Phases of Purchase Process will be described in the context of selling/buying a house.
Need Emerging 211: Before you even consider buying a house, you must first determine whether or not you have a need for one.
Need Defining 212: If you find that, indeed, a house is needed, you must then consider the criteria by which your product options may vary: for example, location, price, and the type of house (bungalow? two-storey? etc.). At the end of this stage, you would define your views on the relevant criteria (VOC)—you would, in other words, have a fairly detailed impression of the sort of house you would like in each of the above criteria. These views on criteria, flexible to some degree, become the basis for your real-world search on the real-estate market.
Selective Qualifying 213: With your VOC in mind, you winnow those builders, sellers and parts of town that don't conform to your preferences, and concentrate on that subset of builders and agents who might be able to provide you with the home you have envisioned.
SeLecting 214: Once you have selected some germane agents and builders, you weigh the pros and cons of each house and, if all goes well, select the one that most closely conforms to your views on criteria. Here the actual exchange takes place.
Follow-up and Control 215: After living in a house for a year or so, you would probably be able to gauge your satisfaction with the house and its features. (You have also presumably been enjoying and evaluating the various ancillary “perks” —warranties, discounts and the like—that the real estate agent or builder has built into their product.) At this point, you are able to come to an honest realization as to whether the choice you made satisfied your initial and evolving expectations.

DataBase 216: Through this process of post-purchase evaluation, you would enhance your existing knowledge about home buying and accrue new knowledge that contributes to your own internal DataBase (DB). This data base would in turn influence future behaviors in situations that are similar to that of buying a house.

From the purchaser's perspective, the organizational PPP 210 covers the entire procurement process. From the sales operator's perspective, the organizational PPP 210 is a relatively public and accessible indicator that allows him or her to appreciate the dynamics of decision-making in the purchasing organization, and get adequately prepared for the next stages of the purchasing process. From the sales manager's perspective, the organizational PPP 210 represents a tool that helps him or her track the actual state of the target business transactions and achieve the sales targets.

To model the influence and roles of the people who run the organizational PPP 210, the present invention defines the concepts of Purchase Roles (PR), Key Persons (KP) 335, Core Opinion Leader (COL) 330 and Competition Agency (CA) 340. These are illustrated in FIG. 3A and FIG. 3B. From the purchaser's perspective, the process has two sides: “pay money” and “buy product”. For each of these two sides, there exist three roles: “approval”, “suggestion” and “use or management”, which are called Purchase Roles (PR) in the present invention. According to FIG. 3A, at any individual phase of the PPP 210, there are six possible roles: PR-MA 300, PR-MS 310, PR-MU 320, PR-PA 305, PR-PS 315 and PR-PU 325, which are used in the present invention. Key Persons (KP) 335 are those people who play these PR at a particular stage of the organizational PPP 210. Among the KP 335, there are those people who have a clearly strong influence (be it positive or negative) upon the buying decision-making process, without being necessarily a decision maker—These people are the Core Opinion Leader (COL) 330. Competition Agency (CA) 340 refer to the ones whose influence is always negative. Within the CNM framework, a person can play one or more PR, and a PR can be shared by several individuals.

To help capture the views of the KP 335, the invention defines the concept of Views On Criteria (VOC) 239 which refers to the information about the criteria that a KP 335 uses to judge the values that he or she pursues in the situation in which the purchase need has emerged. VOC 239 is characterized by two elements: the Selecting Points (SeP) 140 and the Selecting Rationale (SR) 141. Selecting Points 140 are the specific factors, aspects or characteristics that must be present in a sales offer for a KP 335 (or COL 350) to consider making (or recommending) a purchase. Each Selecting Point 140 has a reasoning behind it—the motive or logic accounting for why a KP 335 or COL 350 specifically values the corresponding SeP 140. This reasoning is referred to in the present invention as the Selecting Rationale 141.

To develop concrete ways of handling KP's VOC 239, the present invention introduces the concepts of Buying Points (BP) 247 and Selling Points (SP) 246. These represent the actual expression of value from the customer's perspective. The views of a KP 335 are influenced by two discrete spheres: namely, the personal, and the socio-cultural. BP 247 originate from the former sphere; they refer to those factors that may motivate the KP 335 (as an individual agent beholden to no-one) to make a purchase. They thus reflect individual benefits, i.e., the immediate dividends the product may yield to the purchaser's life. SP 246 originate from the latter sphere and refer to those factors that enable the KP 335 to culturally or socially justify—in effect, “sell”—his or her purchase to those whose opinions he or she values or whose approval he or she requires. SP 246, thus, reflect collective benefits and dividends, rather than individual ones. From the purchaser's perspective, the term “Product” refers to a set of BP 247 and SP 246 that are endorsed by this purchaser's VOC 239.

The foregoing definitions and explanations of KP 335, PR, VOC 239, BP 246, and SP 247 pertain to the dashed box labeled “Cognitive Psychology” in FIG. 2A. Cognitive Psychology (including its applications in Social Psychology) is the scientific discipline that underlies these concepts and that can be used by the seller to assemble the characteristics corresponding to each of these concepts in a sales process. Once these characteristics are assembled, the present invention allows the seller to use them as input to form judgments about how the sale is processing, and to estimate its chances of success. For this purpose, this invention introduces three easy-to-implement Selling status Indicators (SI) 250. The Relating status Indicator or Relating Indicator (RI) 251 is concerned with the comfort level of the seller's personal relationship with a KP 335. It objectively evaluates the effectiveness of the relationship on the basis of how much relevant information (i.e., information conducive to the sales process) the KP 335 has volunteered. It is measured by four incremental stages: CRITICAL STAGE, the KP 335 is silent—or obviously unwilling to discuss any issues pertinent to the sale; PUBLIC RELATIONS STAGE, the KP 335 speaks only officially, divulging information that can be easily obtained through public channels. ACQUAINTANCE STAGE, the KP 335 speaks relatively freely on business matters. The information offered is probably not secret, but perhaps difficult to glean through public channels. PARTNER STAGE, the KP 335 has shared any relevant information with the seller, including but not limited to information that may or may not be considered privileged.

The Attitude Indicator (AI) 252 concerns the attitude of a KP 335 towards the various BP 247. It is a measure of how the KP 335 rates the significance, according to him or her, of each BP 247. It therefore considers the purchaser's perception of how likely a given sales offer (or, more specifically, each BP) is to bring him or her closer to happiness.

The Confidence Indicator (CI) 253 is defined as the extent to which a KP 335 has publicly acknowledged the SP 247 of the seller's offer (product or service or process to provide product or any other related element). The term ‘Extent’ is understood, here, to refer both to the amount or prominence of acknowledgment, and also to the type or forum of acknowledgment.

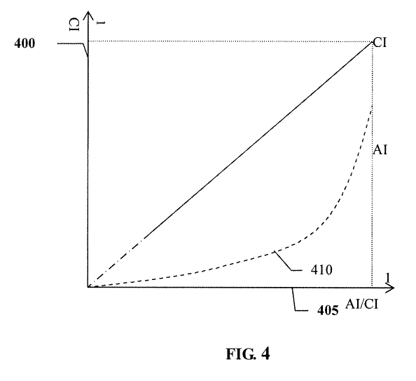

All three indicators take values between 0 and 1 (0 being worst, and 1 being best). They are to be estimated and updated by the seller (who is, in most cases, the sales operator—the different CNM User Roles are discussed later) based on the information collected by this seller during the sales events 240 (FIG. 2A, lower box) that he or she organizes to interact with the KP 335. In some cases, it may be difficult for the seller to estimate the CI 251 at the end of a sales event 240. This is why the present invention introduces algorithms to convert the AI 252 to the CI 251, as the AI 252 is generally easier to assess. FIG. 4 shows an example of a chart (CI axis 400, AI/CI axis 405 and AI as dashed line 410) that implements such a conversion algorithm (use of this algorithm is illustrated later in the Overall Example).

All items within the box CNM-VS 220 (“CNM-VS in the sales process”) of the FIG. 2A have been explained, except the item ‘Appropriate Communicator’ 275. The Appropriate Communicator (AC) 275 is anyone who can help a seller to better present the virtues of the sales offer, and advocate for the seller's cause to bring the sale to consummation. The concerns and attentive focus of the purchasing organization may change as it passes through the PPP 210. Indeed, different KP 335 become involved at different phases of PPP 210 to emphasize different Selecting Points 140 on the basis of different Selecting Rationale 141. As a consequence, besides the seller him or herself, a seller may need to consider finding and mobilizing other communicators to effectively facilitate communications with those disparate KP 335. For example, the AC 275 for a KP 335 concerned with quality will probably be a quality-control engineer or manager, while the AC 275 for a KP 335 concerned more with storage and stock management will be a logistics manager. The seller can find the AC 275 in the network of professional relationships that he or she would have built and which is termed Networked Resources (NR) 260 in the present invention. The NR 260 a salesperson has, whether they are from the relevant industries, his or her own company, or are simply satisfied customers, are indeed a priceless asset in convincing new customers as to the value of a sales offer, and in putting them at ease during the transaction.

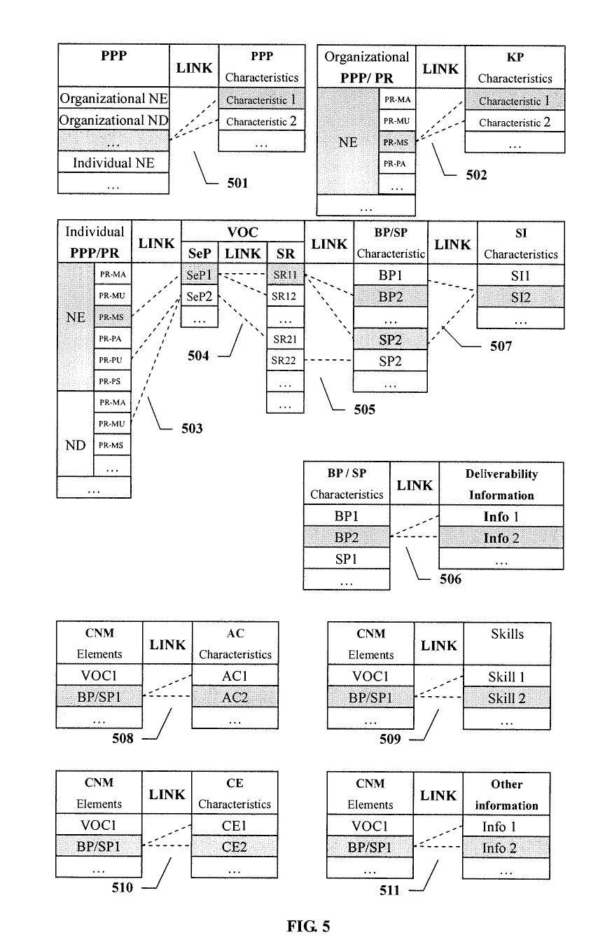

As FIG. 2B explains, the CNM-VS 220 could be viewed as a single frame in a film, and the sales process as a film that is formed by a series of CNM-VS 280(1), 220(2) and 220(n). At any specific phase of organizational PPP 210 and any given point in time within this phase, CNM-VS 220 can be described using the above explained concepts: Individual PPP 225, KP 335, PR 221, VOC 239, BP/SP 245 and SI 128. The various items that make up the CNM-VS 220 (see FIG. 2A) are called CNM Elements 165 in the present invention. Those CNM Elements 165 which are impedances to the progress of sales are referred to as Competition Elements (CE) 170 (not represented in FIG. 2A). The CNM framework 100 in the present invention provides logical relationships among the CNM Elements 165. To express these relationships, the invention introduces the concept of CNM pattern library 180, examples of which are presented at FIG. 5. A CNM pattern refers to a link between CNM Elements 165, such as patterns 501 to 511 in FIG. 5. The CNM pattern library 180 is a reusable knowledge base for storing CNM Elements 165 and the logical relationship among them. This knowledge base is to be built over time by the salespeople based on their experience with the previous CNM processes. Consultants who are familiar with the purchasing organization's industry can also contribute to the development of this base, as each industry has a set of CNM patterns that is specific to it. The CNM pattern library 180 represents a core resource of any selling organization, and it should be the duty of each and every member of the sales team to update it and refine it.

FIG. 5 shows the basic components of CNM pattern library. For instance, the pattern 501 describes the PPP 210 in terms of their characteristics (e.g., the SQ is usually characterized by the fact that “the customer organization is looking at qualifying factors based on some kind of VOC”); the pattern 502 describes the PR 221 at each stage of the PPP 225 in terms of the characteristics of the KP 335 who play these roles (e.g., the PR-PA is played by the “Vice-President of Manufacturing, engineering background, age in the mid-thirties, etc.”); 503 characterizes the PR 221 in terms of the SeP used by the KP 335 playing these roles; 504 explains the VOC-Selecting Points 140 in terms of the Selecting Rationale 141; 505 links the VOC 239 to the BP/SP 246/247; 506 outlines how the BP/SP will be delivered (e.g., BP=“KP appreciates traveling abroad”, Deliverability Information=“The seller informs the KP that his company has just organized an event in which 50 of its customers visit its US headquarters”); 507 assigns values to the Selling Status Indicator (SI) 150 (specifically, the AI 252 and CI 251) based on information collected by the seller regarding what the KP 335 say and do about the BP/SP 246/247 (as per the definitions of the SI); 508 links CNM Elements (VOC, BP, SP, etc.) to the characteristics of the AC 275 who should be assigned the task of communicating with the purchasing organization to address these CNM Elements; 509 links CNM Elements (VOC, BP, SP, etc.) to the type of skills that may be required for the seller to deal with the corresponding CNM element; 510 identifies and characterizes possible CE 170 among the CNM Elements 165; 511 is a generic pattern that links CNM Elements to other types of information (e.g., cost, time location, industry, etc.) that is relevant, actionable and useful to the seller.

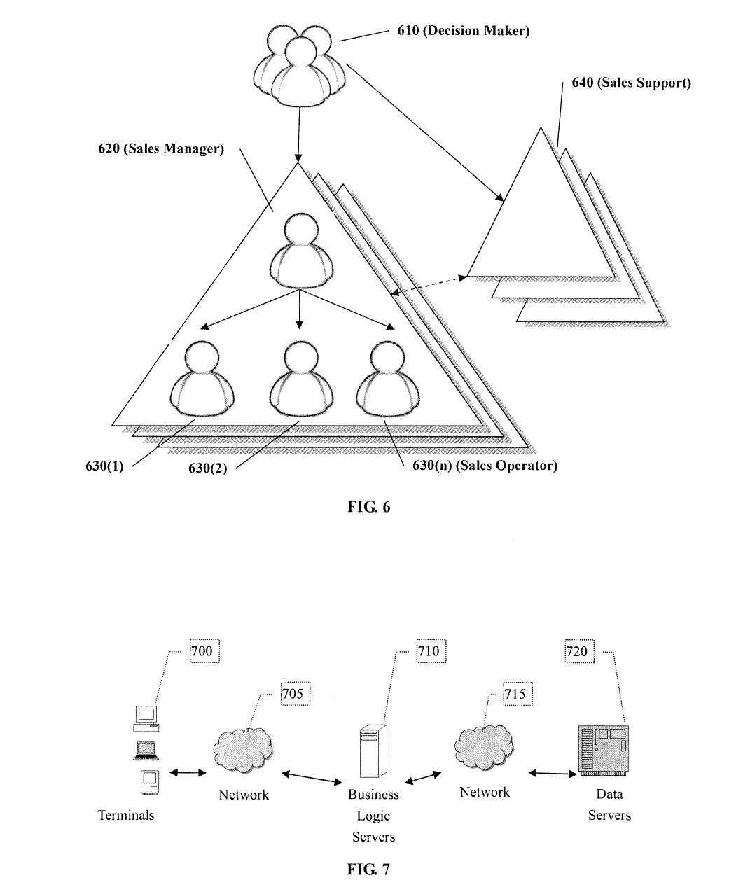

Having defined the meaning of CNM Elements 165 and CNM pattern library 180, there is a need to refer back to FIG. 2B, and note that this figure defines the sale process as a series of CNM-VS 220, in the same way as a film is a series of frames. In the present invention, the sales operator (FIG. 6—to be discussed later) is the one who designs the frames (i.e., CNM-VS 220) for the film (i.e., sales process). He or she carries out this design by running “sales events” (as displayed in the lower box labeled “Sales operator perspective” in FIG. 2A.); in these events, the sales operator must constantly work on the following four tasks: “identifying key persons” 241, “identifying and/or activating needs” 244, “offering benefits” 248, and “reporting sales results” 249 to his or her manager. In the present invention, the task 241 is to be tackled using the concepts of PR 121, KP 335, COL 330, CA 340, AC 275 and related CNM pattern library 180 components (FIG. 5); the task 244 is to be tackled using the concepts VOC 239, AC 275 and related CNM pattern library 180 components (FIG. 5); the task 248 is to be tackled using the concepts SP 248, BP 247, AC 275 and related CNM pattern library 180 components (FIG. 5); 249 is to be tackled using Selling Status Indicators 128, AC 275 and related CNM pattern library 180 components (FIG. 5). From the sales manager perspective, there are also four key points (see FIG. 2A): 251, which is anchored in 241; 256, which is anchored in 244; 257, which is anchored in 248; 258, which is anchored to 249.

The last items in FIG. 2A that need to be discussed are the “Actual Sale” 285, “Conservative Sale” 290, “Confident Sale” 295, and “CNM Maturity” 298. These are tools used in the present invention to evaluate the effectiveness of the sales activities and prepare sales forecasts for the purposes of making decisions and taking appropriate actions. “CNM Maturity” 298 is a measure (between 0 and 1) that evaluates the degree of maturity of a selling organization (or a salesperson) in implementing the CNM framework 100. This measure increases as the organization (or the salesperson) acquires more experience with this framework. “Confident Sale” 295 and “Conservative Sale” 290 are two quantified indices that are used to prepare and analyze sales forecasts, while “Actual Sale” 285 is the sale that has already occurred. The present invention designs and makes use of different functional formulas for “Confident Sale” 22 and “Conservative Sale” 23 depending on the current phase of PPP 210. For example, in the ND 212 phase of PPP 210, the functional formula of “Conservative Sale” 290 may be: Conservative Sale=f_{ND}(a, b, m, M, t) where “a” represents the customer's budget, “b” represents the CI 251, “m” represents sales operator's CNM Maturity, “M” represents the selling organization's CNM Maturity, and “t” represents the time span between the current time and SL 214. On the other hand, in the SQ 213 phase of PPP 210, the functional formula of “Confident Sale” 295 may be: Confident Sale=f_{SQ}(a, b, c, m, M, t) where “c” represents RI 253, and the other parameters are as in the previous formula. Such formulas will be made more explicit and illustrated in the Overall Example.

FIG. 6 shows examples of CNM user roles. In any enterprise engaged in selling, the users of the CNM framework 100 may be categorized into four different roles: the sales operator 630, the sales manager 620, the decision maker 610, and the sales support 640. An individual can assume multiple roles, and many individuals may share one role. When a person performs “sales operation” duties, he or she is considered to assume the sales operator role 630; when a person performs “sales management” duties, he or she is considered to assume the sales manager role 620; the meanings of the other roles may be deduced by analogy.

FIG. 7 shows a computer distributed environment in which the present invention may be deployed. The environment includes a network (705 and 710) such as, for example, the Internet or the organization's Intranet. A number of CNM user terminals (desktop computers, laptop computers, hand-held devices, etc.) are connected, constantly or intermittently, in a wired or wireless fashion to the network 705/710. Also, a number of business logic servers and data servers are connected to the network 705/710 which allows the servers and terminals (700, 710 and 720) to communicate with each other. Each terminal 700 may be owned and operated by a different CNM user. For example, a terminal 700 can be located at the residence of a sales manager; another terminal 700 can be at the office of the CEO, while other ones are used by salespeople on their business trips. The terminals and servers 700, 710 and 720 run an integrated software that supports the services provided by the present invention. This software also supports data exchange across the network 705/710 and display a human-readable interface on the terminals of CNM users. For instance, a terminal 700 may send, through network 705/710, a data request to business logic servers 710, which get the request, handle it, interact with data servers 720 and send a response back to the terminal 700. Also, the business logic servers 710 may push data onto terminal 700, through network 705/710, without getting any data request. The business logic servers 715 can get data from or set data to the data servers 720. Data servers 720 store data, handle data requests from business logic servers 710 and respond to them.

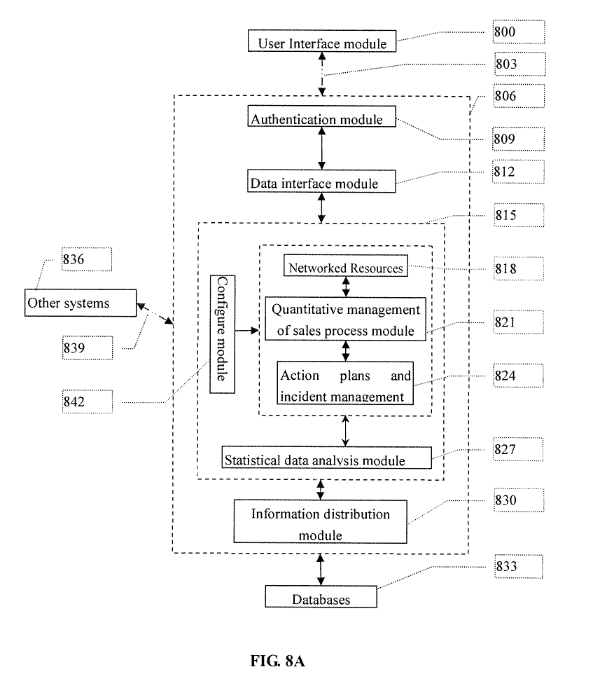

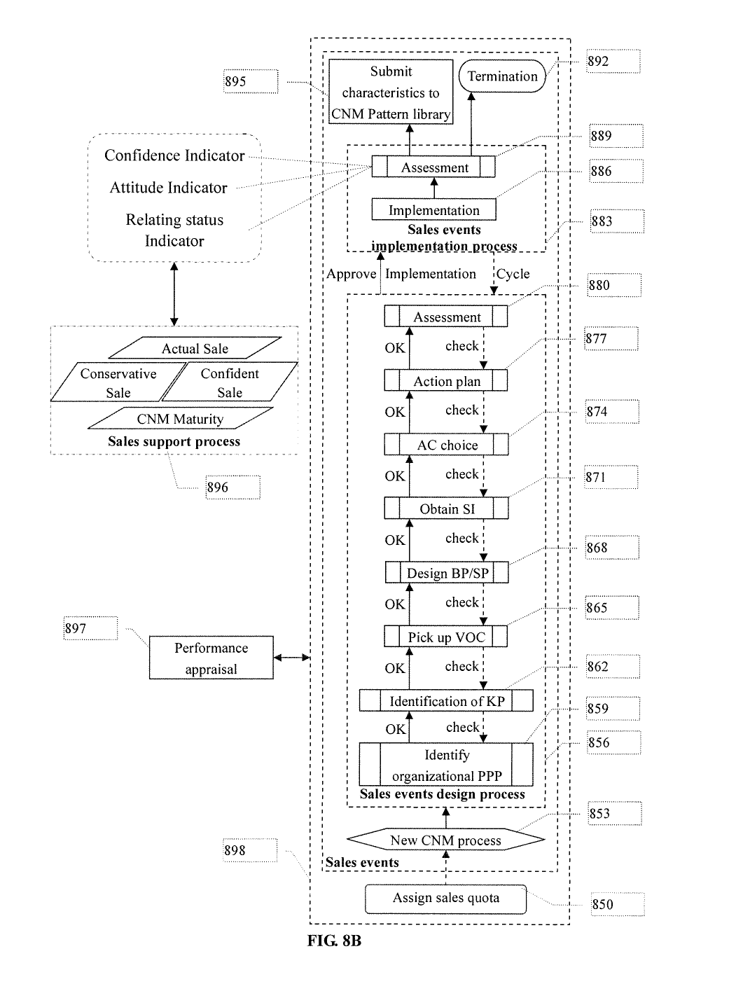

FIG. 8A shows an overall flowchart of the different steps of the system. User Interface 800 is a module to show human-readable user interface to CNM users and handle related data processing, which may be used in 700; Network handling 803 is a module to handle the network connectivity and related data transmission, which may be used in each of 700, 710 and 720; Business logic module 806 is a module to deal with business rules, data algorithms, data encryption, data analysis, data extraction and intelligent decision-making support and other software related functions, which may be used in business logic servers 710; Database module 833 is a module to handle data storage, data optimization, automated data processing and related functions, which may be used in Database servers 720.

In the present invention, referring to business logic module 806, authentication module 809 may be used for certification authority for CNM users; Data interface module 812 may be used for handling data from 800; 815 is the core module of 806. In 806, Configure module 842 may be used for setting parameters of CNM system; Networked Resources module 818 may be used to handle Networked resources 260 and AC 275 (FIG. 2A); Quantitative management of sales process module 821 may be used to handle the overall sales process in FIG. 2A; Action plans and incident management 824 may be used to handle sales events 165; Statistical data analysis module 827 is used for statistics, calculations and analysis CNM data; Information distribution module 830 is used to push CNM information or other information to CNM users.

There are two ways of data flow in the present embodiment: “push” and “pull”. “Pull” could be triggered by a “request” from a CNM User (Terminal 700); “Push” could be triggered by a “timer” from the business logic servers 710.

FIG. 8B shows an flowchart of Quantitative management of sales process module 821, which is the core module in the present invention. The flowchart 856 provides a design process for sales events, which are designed, before they occur, according to the CNM framework 100 in the present invention. Sales events implementation flowchart 883 shows a process for implementing the sales events. 856 and 883 are primarily the responsibility of the sales operator 630. Sales management module 898 is primarily the responsibility of the sales manager 620. Sales support 896 is primarily the responsibility of the sales support person 640. In the present invention, 856 and 883 are the foundational process of this system. 898 and 896 are operations on the foundational process. A CNM process includes a series of sale events (856 and 883).

In the present invention, specific configuration data can be supplied to the System “Configure module” 842 in order to customize the system features and adapt them to a specific application. These data include, but are not limited to the following items: specific product information, the process information, user registration information, user authority information, time and cost standards information, algorithm information, CNM pattern information and so on.

There are two states in the CNM system: “design state” and “conclusion state”. “Design state” represents a planning state about something has not occurred yet. For example, before sales operator 630(1) communicates with a KP 335 about a specific VOC-Selecting Points 140(1), sales operator 630(1) thinks (or assumes) that KP 335 is concerned with this VOC-Selecting Points 140(1) and some related VOC-Selecting Rationale 141. Based on this assumption, the sales operator 630(1) designs some BPs/SPs 246/247 that meet this VOC-Selecting Points 140(1). “Conclusion state” represents a description of something that has occurred, confirmed or delivered. For example, after sales operator 630(1) communicated with a KP 335 about the specific VOC-Selecting Points 140(1), this sales operator 630(1) realizes that KP 335 must be concerned about this VOC-Selecting Points 140(1) and some related VOC-Selecting Rationale 141. Based on this “conclusion”, the sales operator 630(1) designs some BPs/SPs 246/247 in order to meet this VOC-Selecting Points 140(1).

In the present invention, a CNM element 165 in “conclusion state” is always accompanied with traceable information. Traceable information includes “record track” and “logic track”. “Record track” is a fact which can be attested by a third-party person or information. “Logic track” refers to the clear logical relationship between CNM elements 165 and the “record track”. For example, a traceable information about the statement “The customer's PPP 210 is in the SQ 213 stage” would be an “official document that points out clearly that that this bid time”. The “official document” is a “record track”; the use of “bid time” as an indication of the SQ 213 stage is a “logic track”.

Referring to FIG. 8B, in 856, all designed CNM elements 165 should be consistent with the logic of the patterns. In a specific PPP 225 stage, the KP 335 who plays certain purchase role 121 will have certain VOC 239; this VOC leads to a design of certain BP/SP 246/247, and vice versa. For example, in the “design state”, a sales operator 630(n) may design a new sales event 240(n) in the module 856 based on the “conclusion state” information from previous sales events and CNM pattern library 180. After this sales event 240(n) is finished, sales operator 630(n) may submit a new pattern to the system, which may be used in another CNM process of another sales operator.

A Specific CNM Process:

In a specific CNM process, when the sales operator 630(n) discovers a worthy sale opportunity, which should have at least two factors: the target client has a budget related to the purchase and the current stage of the organizational PPP 210 is before the FC 215, he or she adds a new CNM process (853) into the module 821. After some background investigations (information sources including, but not limited to the CNM pattern library 180, networked resources 260, various media channels or previous sales event), 630(n) may start to design the first sales event 240(1). In real cases, the step at which the design is initiated depends on the background information collected. In the present example, we start to design the sales event 240(1) from “Identify organizational PPP” 859. According to patterns 501 (organizational PPP 210 characteristics) in the CNM pattern library 180 (as in FIG. 5), background investigations, and other available information, 630(n) identify the current phase of the organizational PPP 210, and input the PPP stage data into the CNM system. After the data is input into the CNM system, this system displays a message to 630(n) to specify whether the input data is valid or not. If it is valid, the system will permit 630(n) to move to the next step; if not, the system will disable the interface for the next step, and give an alert message to 630(n). After the step “Identify organizational PPP” 859 is done, based on the current stage of PPP 210 and the patterns 502 (as in FIG. 5), the module 821 could give 630(n) intelligence to help him or her in the “Identification of KP” 862. And, to get a specific person, 630(n) may also use the “Networked Resource” 260 in Networked Resources module 818, which stores a large amount of customers data including demographic information, relationship information, contact information, and CNM information. Referring to “Pick up VOC” 865, and based on the background information, the specific characteristics of KP 335/Puchaser Role 121, and the patterns 503 (VOC-SeP Characteristics related to KP/PR) and 504 (VOC-SR Characteristics related to VOC-SR), 630(n) may pick up some VOC-Selecting Points 140 and related VOC-Selecting Rationale 141, and input that information into the system.

The rest may be deduced by analogy; 630(n) may finish the “Design BP/SP” 868 process with the help of patterns 505(BP/SP Characteristics related to VOC-SR); finish the “Deliverability information” of 868 with the help of patterns 506 (Deliverability information related to BP/SP Characteristics); finish the “Obtain SI” 871 process with the help of patterns 507(SI Characteristics to BP/SP Characteristics); finish the “AC choice” 874 process with the help of patterns 508 (AC Characteristics related to CNM elements). At this moment, 630(n) finishes the CNM elements design for a sales event. Based on this information, 630(n) could start to design “Action plan” 877, by looking at 5W (why, who, what, where, when)+1H (how)+2C (time cost and money cost). In the present invention, “Why” is always focused on the CNM elements of the present invention, and “Who” is always focused on the AC 275 who was chosen in the 877 process. The function of the “Assessment” step 880 is to evaluate the rationality and operability of the present sales event design. Depending on the system setting, the appraiser may be a sales team, or a single person. If the sales event design goes through the assessment, sales operator 630(n) could move onto the “Sales events implementation process” 883; if not, 630(n) may need to return backward to the problem step and redesign again, or cancel the current CNM process directly. It should be noted that the steps in the module 856 are interlinked; to re-design a certain step, one must consider re-designing other associated steps.

In the “Implementation” 886, 630(n) communicate the VOC 239 information to the targeted KP 335, provide BP/SP 246/247 to them, and pick up their Selling Status Indicator 150. Then the sales operator 630(n) input the data collected in 886 into the system, and the sales event state change from “design state” to “conclusion state”. 630(n) update the CNM elements filled in the “design state”; each updated CNM element has the “traceable information” to support it.

After 886, the “Assessment” step 889 evaluates the whole sales event. One of the results of this step is to assign values to Selling Status Indicator 150, and input them into the system. Depending on the outcome of the “Assessment” step 889, and unless a termination 892 of the current CNM process takes place, the CNM process will enter the next sales event at the step 859.

If sales operator 630(n) picked up a new pattern in the sales event, he or she could submit it into CNM pattern library 180 (step 895).

Sales manager 620(n) checks the CNM process of sales operator 630(n) through his or her terminal 700. 620(n) could view and navigates through CNM data in the CNM process. As explained in FIG. 8B, sales management process 898 is based on the sales events design process 856. Referring to 856 in FIG. 8B and 251, 256, 257 and 258 from FIG. 2A, there are many check points to monitor the performance of the sales activities and achieving a business goal. 620(n) could objectively evaluate the contents of the activities carried out by the sales operator 630(n), as well as the progress or progress status of a targeted business transaction. In the present invention, sales managers 620 could monitor the progress of the business transaction within a short time period, and appropriately advise the sales operator 630 in charge of the transaction to enhance performance. Similarly, the decision maker who supervises the sales managers could also objectively evaluate the contents of the activities carried out by sales managers 620. The activities of the sales managers 620 include but not limited to:
Assign a sales quota to the sales operator 630 according to their CNM Maturity 298.
Help the sales operator 630 with the critical aspects of the sales event design process 856.
Approve design and assess results in the process of 880 and 889.
Check and verify the “conclusion state” of the CNM data supplied by sales operator 630.
Control time and money costs in each of the check points.
Help the sales operator 630 to assess Selling Status Indicator 150 after he or she finished an important sales event.
Advise the sales operator 630 on specific CNM elements.
Evaluate the performance of the sales operator 630 based on their CNM processes.
Routine management, organization and training, and so on.

The sales support process 896 is also based on the sales events design process 856. Based on 856, the activities of the sales support person 640 include but not limited to:
Support the sales operator 630 and sales manger 620 to design sales events based on the 856.
Deal with the sales support work (such as personnel, finance, production, purchase and distribution, etc.) based on the values of Actual Sale 285, Conservative Sale 290 and/or Confident Sale 295.

For the decision maker 610, the most important data to him or her is SI related; i.e. the Actual Sale 285, the Conservative Sale 290, and/or the Confident Sale 295.

### Overall Example

In this example, assume that the company named “CNMER” uses the CNM system of the present invention to manage their customers' needs and sales activities. “ANYPROD” is the company's product, whose price ranges between $1 million and $5 million depending on the product's configuration. Sales person “S” is working for “CNMER” and sales manager “SM” is the supervisor of “S”. For a clear illustration of the usage of the CNM system, it is assumed that the following configuration example for the “Configure module” 842 is given:

(1). CNM User Roles and CNM Maturity 298:

Assign CNM User Role 630 to “S”; assign CNM User Role 620 to “SM”.

The current value of CNM Maturity 298 is set to 0.8 for the company CNMER, and to 0.6 for the sales person “S”.

(2). CI Formula:

FIG. 4 shows an example of a curve formula for CI 251 as a function of AI 252. The curves 410 could be expressed as fCIAI. Given an AI value, computer could calculate a CI value according to fCIAI. If there is more than one KP 335 involved in the current CNM-VS, the integrated formula to be used in the present invention is: Σ(<CI of each KP>×<influence percentage of the KP>), Σ represents sum. For example, if there are 2 KPs in a CNM-VS whose CI 251 and influence percentage are: 0.2, 40% and 0.3, 60% respectively, the integrated CI value is: 0.2×40%+0.3×60%=0.26.

(3). Formulas for the “Sales Success Rate”, the “Confident Sale” 295 and the “Conservative Sale” 290:

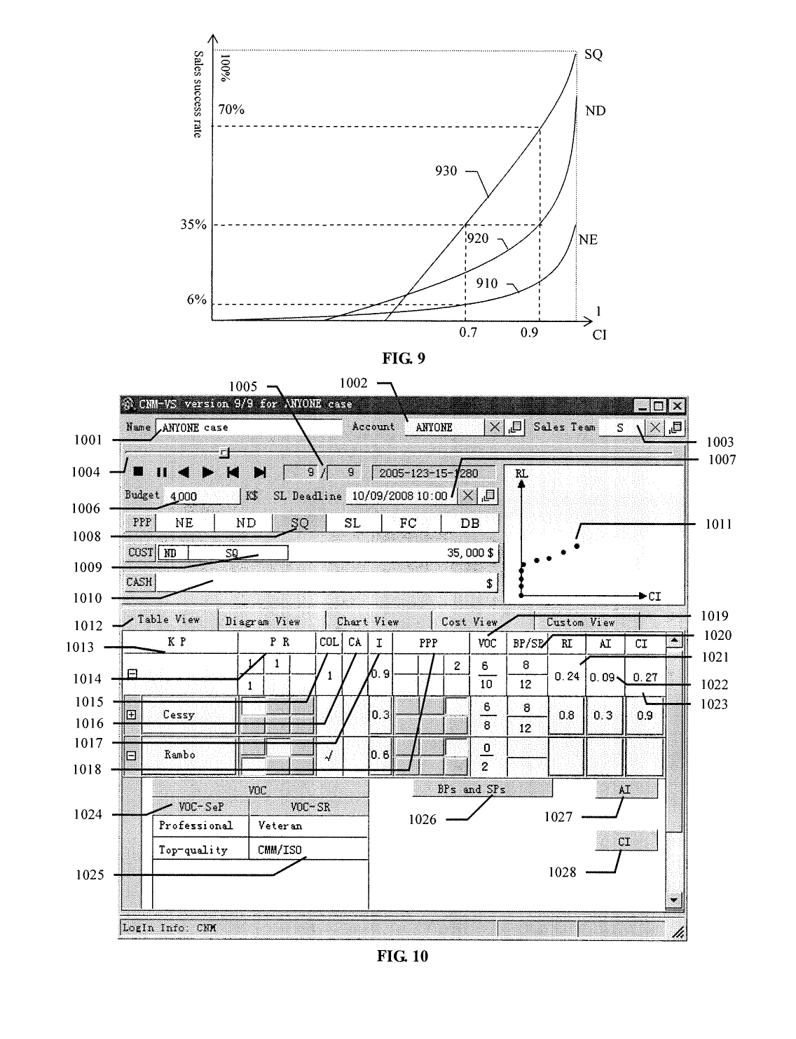

FIG. 9 shows an example of curve formulas to evaluate the “Sales success rate” depending the value of CI 251. 910, 920 and 930 are three curves for the “Sales success rate” as a function of the CI 251, when the organizational PPP 210 is in the NE 211 stage, the ND 212 stage and the SQ 213 stage respectively. These three curves could be coded as f_{NE}CI, f_{ND}CI and f_{SQ}CI in the computer. In the current example, if the current stage of PPP 210 and the current value of CI 251 are available, the computer can easily figure out the value of the “Sales success rate” from the FIG. 9.

The “Conservative Sale” 290 formula is: b×(fNECI, fNDCI or fSQCI)×m/M; and the “Confident Sale” 295 formula is: b×(fNECI, fNDCI or fSQCI)×RI×m/M. In these formulas, “m” represents CNM Maturity 298 of sales person “S”, “M” represents the CNM Maturity of company “CNMER”, “RI” is Relating Indicator 253, and “b” represents the budget of the customer. For an integrated sales forecast in a time period, the integrated formula is: Σ(b×(fNECI, fNDCI or fSQCI)×m/M) or Σ(b×(fNECI, fNDCI or fSQCI)×RI×m/M). For example, assume “S” has 2 CNM-VS at his or her disposal, and the PPP 210 will reach the SL stage 214 in a month. The customer's budget, PPP 210 stage, CI, RI in the two CNM-VS are: “100, NE, 0.7, 0.6” and “200, ND, 0.9, 0.8” respectively. Referring to FIG. 9, “Sales success rate” for these CNM-VS are 6% and 35% respectively. Thus, a sales forecast for “S” in the next month is:

“Confident Sale” 295: 100×6%×0.6/0.8+200×35%×0.6/0.8=57

“Conservative Sale” 290: 100×6%×0.6×0.6/0.8+200×35%×0.8×0.6/0.8=44.7

(4). Formula to Evaluate the Sales Operator “S”:

This formula is based on the following items:

| Items | symbols | score |
|---|---|---|
| Real Sale | B | 0~50 (previous quarter) |
| Sales forecast | C | 0~30 (next quarter) |
| Networked resources | E | 0~20 |
| Submit a pattern | F | 0.1~5 |

The evaluation formula is: B+C×m/M+E+F.

To evaluate the sales forecast C, the following formula is to be used:

(Conservative Sale+Confident Sale)/(quota×2)

(5). An Example of Rules Regarding the “Assessment” Step 880:

Sales Manager 620 gets to assess the design of a sales event if: (1) its time cost is over 1 day, or (2) its money cost is more than $100. Sales operator 630 doesn't have this right.

(6). A Few Examples of the Patterns that can Appear in the CNM Pattern Library 180:

An example for the table of the PPP characteristics pattern 501:

| | PPP 210 | PPP characteristics |
|---|---|---|
| → | SQ | The targeted company has |
| | | build a purchase team. |

An example for the table of the PR/KP characteristics pattern 502:

| | PR | KP characteristics |
|---|---|---|
| → | PR-PA | Vice President |
| → | PR-PU | IT manager |
| → | PR-MA | CFO |

An example for the table of the PR/VOC-SeP characteristics pattern 503:

| | PR | VOC-SeP characteristics |
|---|---|---|
| → | PR-PA | Professional |
| | | Top-quality |
| → | PR-MA | Cost-efficient |
| → | PR-PU | Manageable |

An example for the table of the VOC-SeP/VOC-SR characteristics pattern 504:

| | VOC-SeP | VOC-SR characteristics |
|---|---|---|
| → | Professional | Academic |
| | | Veteran |
| → | Top-quality | CMM/ISO |
| | | Public praise |
| | | Certified |
| → | Cost- | Within budget |
| | efficient | Low-cost |
| → | Manageable | Automated |
| | | Stable |

An example for the table of the VOC-SR/BP/SP characteristics pattern 505:

| | VOC-SR | BP/SP characteristics |
|---|---|---|
| → | Veteran | 10 years experience in |
| | | ANYPROD |
| → | CMM/ISO | CMM level 2 |
| → | Certified | CMM level 2 |
| → | Within budget | Give a base price within |
| | | certain budget first |

An example for the table of the SP/CI characteristics pattern 507:

| | SP class | CI characteristics | CI |
|---|---|---|---|
| → | A certain | Visit and give | 0.4 |
| | SP | positive words | |

An example for the table of the BP/SP/AC characteristics pattern 508:

| | BP/SP | AC features |
|---|---|---|
| → | CMM level 2 | CMM Manager in the |
| | | company |
| → | 10 years experience | A senior staff member |
| | in ANYPROD | |

The above patterns in CNM pattern library 180 come from the records of sales operator's CNM experience, the experience of other salespeople in the company and/or the work of consultants.

Action:

In the beginning of a new quarter, “SM” starts up, on his or her terminal 700(SM), the CNM system software that delivers the features of the present invention, goes to the module 850, assigns a $3.5 million quota to “S”, and submits that information to the business logic server 710. The “SM” receives a “successful submission” message on his 700(SM). 710 pushes the “quota” information to “S”. “S” receives the quota information through his or her CNM terminal 700(S). Based on the knowledge of this “quota”, “S” should plan his or her work for the new quarter. “S” may need to check the current CNM process first; “S” sends a “Get current CNM status for the new quarter” request to 710, then the “Statistical data analysis module” S335 handles the request, and responds with the following form to 700(S):

| | CNM process | | | |
|---|---|---|---|---|
| | process 1 | process2 | process 3 | sum |
| Budget | 2 million | 5 million | 4 million | — |
| Current stage of PPP 210 | NE | ND | SQ | — |
| CI 251 | 0.7 | 0.9 | 0.9 | — |
| Sales success rate | 6% | 35% | 70% | — |
| RI 253 | 0.5 | 0.8 | 0.8 | — |
| Conservative Sale 290 | 0.0045 | 1.05 | 1.68 | 2.775 |
| | million | million | million | million |
| Confident Sale 295 | 0.09 | 1.3125 | 2.1 | 3.5225 |
| | million | million | million | million |

The above form shows three CNM process, the PPP 210 of which will reach SL stage 214 within the new quarter. The total Confident Sale in the next term is $2.775 million, and the total Conservative Sale in the next term is $3.5025 million. The above values are calculated with the foregoing formulas: Σ(b×(f_{NE}CI, f_{ND}CI or f_{SQ}CI)×m/M) and Σ(b×(f_{NE}CI, f_{ND}CI or f_{SQ}CI)×RI×m/M). Thus, the integrated sales forecast is: (2.775+3.5025)/2=$3.13875 million. Compared to the “quota” of $3.5 million, the integrated sales forecast is lower. On the terminal 700(S), “S” could read a message about it: “In order to complete the ‘quota’ of $3.5 million, ‘S’ needs to get at least $0.36125 more of integrated sales forecast”.

In order to get more integrated sales forecast, “S” may want to set up a new CNM process. “S” searches Opportunity 231 (see FIG. 2A) from his or her Networked Resources 818, and finds that there is a budget from ANYONE company to make a purchase within the next few months. After having confirmed the budget information and the time information from his or her “Networked Resources”, “S” set up (853) a new CNM process in the CNM system named “ANYONE case”.

After having gone through several processes of sales events design 856 and sales events implementation 883, the “ANYONE account” in the CNM system has now accumulated CNM elements (which have been input by “S”) from those events and structured them into a series CNM-VS 220.

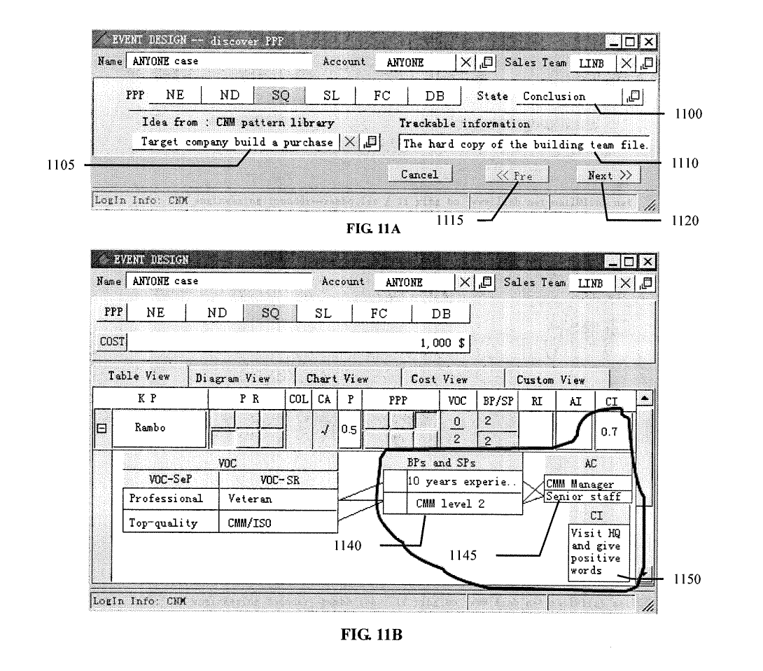

FIG. 10 shows the CNM-VS version 9 of the “ANYONE account”. In this CNM-VS version (see FIG. 10), 1000 represents the current CNM process, which is named “ANYONE case”. 1002 shows the account of the current CNM process. 1003 shows the sales team that is responsible for 1001. 1004 is a control slider and control button that allows user to move to other CNM-VS versions (for instance, move the slider to a bit to the left, the current CNM-VS version will go to version 8). 1005 shows the version information—“9/9” indicates that there are 9 versions in 1001, and the current User Interface shows the ninth version. 1006 shows the budget of 1001. 1007 is the date and time at which the SL stage of PPP 210 will be attained, which means that, by that date and time, 1002 would have already paid its money. 1008 shows that PPP 210 is currently at the SQ stage in the version 9 of the CNM-VS. 1009 displays the cost of 1001, i.e., how much money has been spent so far in the previous PPP 210 stages. 1010 shows how much money has been received from 1001. 1011 is a chart to show information about SI 128, which reflects the performance of the whole CNM process—the X-coordinate of 1011 is CI 251 and the Y-coordinate of 1011 is RI 253. At this point (version 9 of the CNM-VS), there are nine points in the chart (note that the CNM system can plot other indices as well). 1012 shows a “table view” of the current CNM-VS version. 1013 shows the KP 122 information related to 1001 in the current version CNM-VS. As illustrated in FIG. 10, there are 2 KPs in the ninth version of 1001: “Cessy” and “Rambo”. 1014 shows the PR 121 information of 1013—the six blocks, followed left-to-right and top-down, indicate PR-MA 300 (1 KP), PR-MS 310 (1 KP), PR-MU 320, PR-PA 305 (1 KP), PR-PS 315, and PR-PU 325. The KP “Cessy” is PR-MA 300, and the KP “Rambo” is both 310 and 305. 1005 shows that the KP “Rambo” is the only COL 350 in the current CNM-VS version. 1016 shows that the KP “Rambo” and the KP “Cessy” are not CA 340. 1017 shows that the KP Rambo's influence is 0.6, and KP Cessy's influence is 0.3. 1018 shows the individual PPP 239 information for 1013—the six blocks, followed left-to-right and top-down, are NE 211, ND 212, SQ 213, SL 214, FC 215, DB 216. The KP Cessy and Rambo's PPP 225 are both in the SQ 213 stage. 1019 is the VOC 239 information of 1013, which shows that “S” has picked up 8 VOC for “Cessy”, 6 of those VOC have been given BP/SP; “S” has also picked up 2 VOC for “Rambo”, no one of them has been given BP/SP yet. 1020 is BP/SP 246/247 information of 1013, which shows that “S” has given “Cessy” 8 BP/SP; no BP/SP has been given to KP “Rambo”. 1021, 1022, 1023 represent RI, AI and CI, and show that the integrated RI, AI and CI are 0.24, 0.09 and 0.27; KP Cessy's RI, AI and CI are 0.8, 0.3 and 0.9. “S” cannot yet get any SI from KP “Rambo”. 1024, 1025, 1026, 1027, 1028 are, respectively, VOC-SeP, VOC-SR, BP/SP, AI and CI for KP “Rambo” (sign “−”, not “+” is displayed at the left of the name ‘Rambo’ in FIG. 10), which shows that there are only two VOC for “Rambo”.

Based on the above CNM-VS version (9th), “S” may want to design a sales event in order to provide BPs/SPs to the two VOC of KP “Rambo”. “S” goes to the sales event design process module 856 from his or her CNM terminal 700(S), and begins to design a specific sales event.

“S” enters into “Identify organizational PPP” 859 first. FIG. 11A shows an example of the User Interface of S33320. 1100 shows that the PPP stage of 210 is SQ, and this CNM element is in “conclusion state”; 1105 shows the information from the related CNM pattern which is derived from the PPP characteristics pattern 501, while 1110 shows the “traceable information” that supports 1100. “S” may then consider that the PPP 210 is still in the SQ stage; he or she adopts this CNM information picked up from the previous sales event. “S” then clicks “next step” 1120 to move to the next User Interface for the step 862 (the User Interfaces for all the steps are similar to FIG. 11A). In the User Interface for “Identification of KP” 862, “S” selects KP “Rambo” (this is derived from PR/KP pattern 502) as the targeted KP in the sales event to be designed. “S” clicks “next step” again to move to the step 865; “S” selects the following VOC (which are derived from the PR/VOC-SeP pattern 503 and the VOC-SeP/VOC-SR pattern 504) as the targeted VOC in the sales event to be designed:

| VOC-SeP | VOC-SR |
|---|---|
| 1 Professional | Veteran |
| 2 Top-quality | CMM/ISO |

The first line shows that the KP “Rambo” is concerned with the “Professional” aspect of the company, and he thinks that “A company with a long history” means “Professional”; the second line shows that KP “Rambo” is concerned about the “quality” aspect, and he finds that “A company with CMM/ISO certification” means “Top-quality”. The above CNM elements are in the “conclusion state” (referring to 1024 and 1025 in FIG. 10) as well. Then, in the next User Interface for the design of BP/SP 868, “S” selects the following BP/SP, for instance, for satisfying the above VOC of the KP “Rambo” on the basis of the VOC-SR/BP/SP pattern 505 that currently exists in the CNM pattern library:

1 “10 year experience in ANYPROD” for the “Veteran” VOC-SR

2 “CMM level 2” for the “CMM/ISO” VOC-SR

The first line means that “S” thinks that having a “10 year experience in ANYPROD” is a powerful evidence that shows that his or her company meets the KP's criterion “A company with a long history”, i.e. a “Veteran” (KP Rambo's first VOC-SR). The second line means that “S” thinks that the fact that CNMER has a “CMM level 2” certification is an appropriate evidence that shows that the second VOC-SR “Top-quality” is satisfied. The above decisions regarding the BP/SP are in the “design state”.

In the next User Interface for the step “Obtain SI” 871, “S” checks the BP/SP/SI pattern 507 in the CNM pattern library and finds: “Visit to CNMER and give positive words”. Thus, “S” decides to design a sales event that includes taking the following two actions: (1) arranging a visit by the KP “Rambo” and other key persons to CNMER so that they can be introduced to the company's CMM-2 quality certification system, and (2) after the two VOC “Professional” and “Top-quality” are satisfied, prompting the COL “Rambo” to make public comments about the selling point “CMM level 2”. In the next User Interface for the step “AC choice” 874, “S” selects the following AC from the BP/SP/AC pattern 508:

| BP/SP | AC |
|---|---|
| 1 “10 year experience in ANYPROD” | Senior staff |
| 2 “CMM level 2” | CMM Manager |

The first line means that “S” thinks that a “Senior Staff' is an appropriate candidate to communicate the information about having a “10 year experience in ANYPROD”. The second line means that “S” thinks that a “CMM Manager” is an appropriate candidate to communicate the information about the “CMM” information.

In the next User Interface for the step “Action plan” 877, “S” provides an action plan for the above sales event, and specify a budget of $1,000. FIG. 11B shows the User Interface for the design of the current sales event. 1150 shows the CNM elements that are in the “design state”. “SM” and “S” both take part in the assessment step 880; “SM” thinks that the design is reasonable, and approves it.

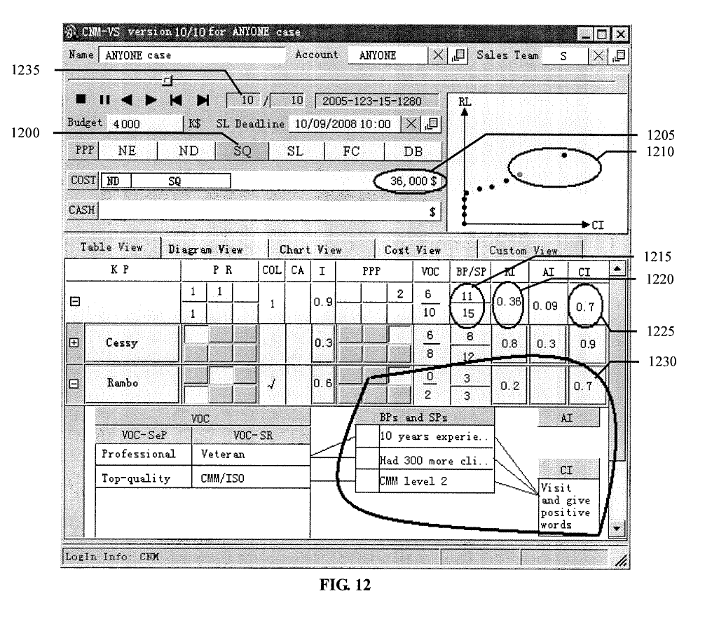

After the approval, “S” implements the sales event (886) according to the design, picks up further CNM elements from the sales event, and updates the data in the CNM system. After that, the CNM-VS is updated to version 10. FIG. 12 shows this version of the CNM-VS. 1200 shows that the PPP 210 stage is still in SQ; 1208 shows that the cost increased to 36,000$ (in contrast to 35,000$ at 1009 in FIG. 10); 1210 shows the plot with the current SI point (in contrast to 1011 in FIG. 10); 1215 shows that there are three more BP/SP that have been added to the CNM-VS (in contrast to 1020 in FIG. 10); 1220 shows that RI increased by 0.12 (in contrast to 1021 in FIG. 10); 1225 shows that CI increased by 0.43 (in contrast to 1023 in FIG. 10). Compare FIG. 11B to FIG. 12, in the area of 1230. It shows that “S” delivered 3 (instead of 2) BP/SP to the KP “Rambo”. In the sales event, “S” got a value of 0.2 for RI (based on the usefulness of the information that he or she obtained from the KP), a value of 0.7 for CI from the KP “Rambo” (based on the extent to which the KP has acknowledged the SP). And, in the BP/SP area, there is a new BP/SP that “S” has found during the actual sales event and offered to the KP: this BP/SP is “CNMER had 300 more clients”. “S” submits the new BP/SP to the VOC-SR/BP/SP pattern 505, and get an extra score of 0.1.

In version 10 of the CNM-VS, the “Confident Sale” for the current CNM process is: 4 million×f_{SQ}0.7×0.6/0.8=4 million×35%×0.6/0.8=1.05 million. Conservative Sale is: 1.05 million×0.36=0.378 million. The integrated sales forecast of the current CNM process is: (1.05 million+0.378 million)/2=0.714 million. At version 10 of CNM-VS, the sales forecast for the new quarter is then: 3.13875 million+0.714 million=3.85275 million. Referring back to the formula for the evaluation of the sales operator, we can use the following values for the items B, C, E, F:

| Real Sale | B | 50 (previous quarter) |
|---|---|---|
| Sales forecast | C | (3.85275/3.5) × 30 ≈ 33.0 (next quarter) |
| Network resources | E | 15 (may be) |
| Submit a pattern | F | 0.1 |

According to the evaluation formula B+C×m/M+E+F, the evaluation score of “S” is:

50+33.0×0.6/0.8+15+0.1=89.85

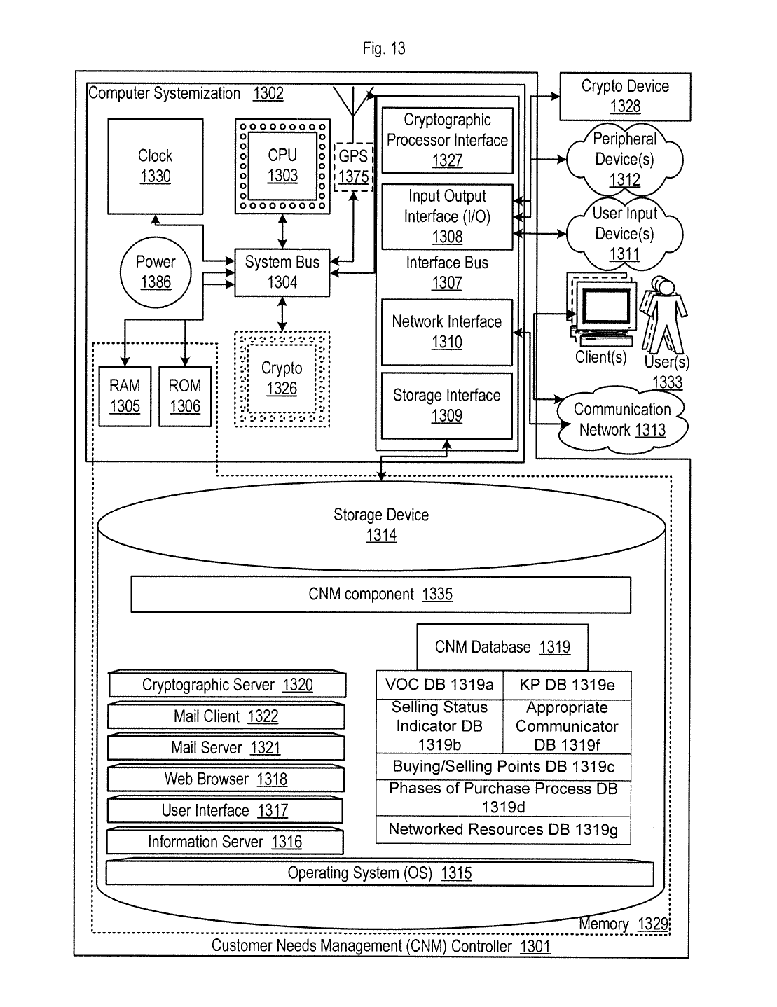

FIG. 13 is of a block diagram illustrating embodiments of the present invention of an language neutral search system controller;

Customer Needs Management Controller

FIG. 13 of the present disclosure illustrates inventive aspects of a Customer Needs Management (CNM) controller 1301 in a block diagram. In this embodiment, the CNM controller 1301 may serve to aggregate, process, store, search, serve, identify, instruct, generate, match, and/or facilitate interactions with a computer through search technologies, and/or other related data.

Typically, users, which may be people and/or other systems, engage information technology systems (e.g., commonly computers) to facilitate information processing. In turn, computers employ processors to process information; such processors are often referred to as central processing units (CPU). A common form of processor is referred to as a microprocessor. CPUs use communicative signals to enable various operations. Such communicative signals may be stored and/or transmitted in batches as program and/or data components facilitate desired operations. These stored instruction code signals may engage the CPU circuit components to perform desired operations. A common type of program is a computer operating system, which, commonly, is executed by CPU on a computer; the operating system enables and facilitates users to access and operate computer information technology and resources. Common resources employed in information technology systems include: input and output mechanisms through which data may pass into and out of a computer; memory storage into which data may be saved; and processors by which information may be processed. Often information technology systems are used to collect data for later retrieval, analysis, and manipulation, commonly, which is facilitated through a database program. Information technology systems provide interfaces that allow users to access and operate various system components.

In one embodiment, the CNM system controller 1301 may be connected to and/or communicate with entities such as, but not limited to: one or more users from user input devices 1311; peripheral devices 1312; a cryptographic processor device 1328; and/or a communications network 1313.

Networks are commonly thought to comprise the interconnection and interoperation of clients, servers, and intermediary nodes in a graph topology. It should be noted that the term “server” as used throughout this disclosure refers generally to a computer, other device, program, or combination thereof that processes and responds to the requests of remote users across a communications network. Servers serve their information to requesting “clients.” The term “client” as used herein refers generally to a computer, other device, program, or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The CNM system controller 1301 may be based on common computer systems that may comprise, but are not limited to, components such as: a computer systemization 1302 connected to memory 1329.

Computer Systemization

A computer systemization 1302 may comprise a clock 1330, central processing unit (CPU) 1303, a read only memory (ROM) 1306, a random access memory (RAM) 1305, and/or an interface bus 1307, and most frequently, although not necessarily, are all interconnected and/or communicating through a system bus 1304. Optionally, the computer systemization may be connected to an internal power source 1386. Optionally, a cryptographic processor 1326 may be connected to the system bus. The system clock typically has a crystal oscillator and provides a base signal. The clock is typically coupled to the system bus and various clock multipliers that will increase or decrease the base operating frequency for other components interconnected in the computer systemization. The clock and various components in a computer systemization drive signals embodying information throughout the system. Such transmission and reception of signals embodying information throughout a computer systemization may be commonly referred to as communications. These communicative signals may further be transmitted, received, and the cause of return and/or reply signal communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s). The CPU interacts with memory through signal passing through conductive conduits to execute stored signal program code according to conventional data processing techniques. Such signal passing facilitates communication within the CNM system controller and beyond through various interfaces. Should processing requirements dictate a greater amount speed, parallel, mainframe and/or super-computer architectures may similarly be employed. Alternatively, should deployment requirements dictate greater portability, smaller Personal Digital Assistants (PDAs) may be employed.

Power Source

The power source 1386 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 1386 is connected to at least one of the interconnected subsequent components of the CNM system thereby providing an electric current to all subsequent components. In one example, the power source 1386 is connected to the system bus component 1304. In an alternative embodiment, an outside power source 1386 is provided through a connection across the I/O 1308 interface. For example, a USB and/or IEEE 1394 connection carries both data and power across the connection and is therefore a suitable source of power.

Interface Adapters

Interface bus(ses) 1307 may accept, connect, and/or communicate to a number of interface adapters, conventionally although not necessarily in the form of adapter cards, such as but not limited to: input output interfaces (I/O) 1308, storage interfaces 1309, network interfaces 1310, and/or the like. Optionally, cryptographic processor interfaces 1327 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 1309 may accept, communicate, and/or connect to a number of storage devices such as, but not limited to: storage devices 1314, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 1310 may accept, communicate, and/or connect to a communications network 1313. Through a communications network 1313, the CNM system controller is accessible through remote clients 1333b (e.g., computers with web browsers) by users 1333a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 1310 may be used to engage with various communications network types 1313. For example, multiple network interfaces may be employed to allow for the communication over broadcast, multicast, and/or unicast networks.

Input Output interfaces (I/O) 1308 may accept, communicate, and/or connect to user input devices 1311, peripheral devices 1312, cryptographic processor devices 1328, and/or the like. I/O may employ connection protocols such as, but not limited to: Apple Desktop Bus (ADB); Apple Desktop Connector (ADC); audio: analog, digital, monaural, RCA, stereo, and/or the like; IEEE 1394a-b; infrared; joystick; keyboard; midi; optical; PC AT; PS/2; parallel; radio; serial; USB; video interface: BNC, coaxial, composite, digital, Digital Visual Interface (DVI), RCA, RF antennae, S-Video, VGA, and/or the like; wireless; and/or the like. A common output device is a television set 145, which accepts signals from a video interface. Also, a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Typically, the video interface provides the composited video information through a video connection interface that accepts a video display interface (e.g., an RCA composite video connector accepting an RCA composite video cable; a DVI connector accepting a DVI display cable, etc.).

User input devices 1311 may be card readers, dongles, finger print readers, gloves, graphics tablets, joysticks, keyboards, mouse (mice), remote controls, retina readers, trackballs, trackpads, and/or the like.

Peripheral devices 1312 may be connected and/or communicate to I/O and/or other facilities of the like such as network interfaces, storage interfaces, and/or the like. Peripheral devices may be audio devices, cameras, dongles (e.g., for copy protection, ensuring secure transactions with a digital signature, and/or the like), external processors (for added functionality), goggles, microphones, monitors, network interfaces, printers, scanners, storage devices, video devices, video sources, visors, and/or the like.

It should be noted that although user input devices and peripheral devices may be employed, the CNM system controller may be embodied as an embedded, dedicated, and/or monitor-less (i.e., headless) device, wherein access would be provided over a network interface connection.

Cryptographic units such as, but not limited to, microcontrollers, processors 1326, interfaces 1327, and/or devices 1328 may be attached, and/or communicate with the CNM system controller. A MC68HC16 microcontroller, commonly manufactured by Motorola Inc., may be used for and/or within cryptographic units. Equivalent microcontrollers and/or processors may also be used. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of CPU. Other commercially available specialized cryptographic processors include VLSI Technology's 33 MHz 6868 or Semaphore Communications' 40 MHz Roadrunner 184.

Memory

Generally, any mechanization and/or embodiment allowing a processor to affect the storage and/or retrieval of information is regarded as memory 1329. However, memory is a fungible technology and resource, thus, any number of memory embodiments may be employed in lieu of or in concert with one another. It is to be understood that the CNM system controller and/or a computer systemization may employ various forms of memory 1329. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation. In a typical configuration, memory 1329 will include ROM 1306, RAM 1305, and a storage device 1314. A storage device 1314 may be any conventional computer system storage. Storage devices may include a drum; a (fixed and/or removable) magnetic disk drive; a magneto-optical drive; an optical drive (i.e., CD ROM/RAM/Recordable (R), ReWritable (RW), DVD RIRW, etc.); an array of devices (e.g., Redundant Array of Independent Disks (RAID)); and/or other devices of the like. Thus, a computer systemization generally requires and makes use of memory.

Component Collection

The memory 1329 may contain a collection of program and/or database components and/or data such as, but not limited to: operating system component(s) 1315 (operating system); information server component(s) 1316 (information server); user interface component(s) 1317 (user interface); Web browser component(s) 1318 (Web browser); database(s) 1319; mail server component(s) 1321; mail client component(s) 1322; cryptographic server component(s) 1320 (cryptographic server); the CNM system component(s) 1335; and/or the like (i.e., collectively a component collection). These components may be stored and accessed from the storage devices and/or from storage devices accessible through an interface bus. Although non-conventional program components such as those in the component collection, typically, are stored in a local storage device 1314, they may also be loaded and/or stored in memory such as: peripheral devices, RAM, remote storage facilities through a communications network, ROM, various forms of memory, and/or the like.

Operating System

The operating system component 1315 is an executable program component facilitating the operation of the CNM system controller. Typically, the operating system facilitates access of I/O, network interfaces, peripheral devices, storage devices, and/or the like. The operating system may be a highly fault tolerant, scalable, and secure system such as Apple Macintosh OS X (Server), AT&T Plan 9, Be OS, Linux, Unix, and/or the like operating systems. However, more limited and/or less secure operating systems also may be employed such as Apple Macintosh OS, Microsoft DOS, Microsoft Windows 2000/2003/3.1/95/98/CE/Millenium/NTNista/XP (Server), Palm OS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the CNM system controller to communicate with other entities through a communications network 1313. Various communication protocols may be used by the CNM system controller as a subcarrier transport mechanism for interaction, such as, but not limited to: multicast, TCP/IP, UDP, unicast, and/or the like.

Information Server

An information server component 1316 is a stored program component that is executed by a CPU. The information server may be a conventional Internet information server such as, but not limited to Apache Software Foundation's Apache, Microsoft's Internet Information Server, and/or the. The information server may allow for the execution of program components through facilities such as Active Server Page (ASP), ActiveX, (ANSI) (Objective-) C (++), C#, Common Gateway Interface (CGI) scripts, Java, JavaScript, Practical Extraction Report Language (PERL), Python, WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the CNM system controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the CNM system database 1319, operating systems, other program components, user interfaces, Web browsers, and/or the like.

Access to the CNM system database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the CNM system. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the CNM system as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

User Interface

The function of computer interfaces in some respects is similar to automobile operation interfaces. Automobile operation interface elements such as steering wheels, gearshifts, and speedometers facilitate the access, operation, and display of automobile resources, functionality, and status. Computer interaction interface elements such as check boxes, cursors, menus, scrollers, and windows (collectively and commonly referred to as widgets) similarly facilitate the access, operation, and display of data and computer hardware and operating system resources, functionality, and status. Operation interfaces are commonly called user interfaces. Graphical user interfaces (GUIs) such as the Apple Macintosh Operating System's Aqua, Microsoft's Windows XP, or Unix's X-Windows provide a baseline and means of accessing and displaying information graphically to users.

A user interface component 1317 is a stored program component that is executed by a CPU. The user interface may be a conventional graphic user interface as provided by, with, and/or atop operating systems and/or operating environments such as Apple Macintosh OS, e.g., Aqua, GNUSTEP, Microsoft Windows (NT/XP), Unix X Windows (KDE, Gnome, and/or the like), mythTV, and/or the like. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

Web Browser

A Web browser component 1318 is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Some Web browsers allow for the execution of program components through facilities such as Java, JavaScript, ActiveX, and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the CNM system enabled nodes. The combined application may be nugatory on systems employing standard Web browsers.

Mail Server

A mail server component 1321 is a stored program component that is executed by a CPU 1303. The mail server may be a conventional Internet mail server such as, but not limited to sendmail, Microsoft Exchange, and/or the. The mail server may allow for the execution of program components through facilities such as ASP, ActiveX, (ANSI) (Objective-) C (++), CGI scripts, Java, JavaScript, PERL, pipes, Python, WebObjects, and/or the like. The mail server may support communications protocols such as, but not limited to: Internet message access protocol (IMAP), Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the CNM system.

Access to the CNM system mail may be achieved through a number of APIs offered by the individual Web server components and/or the operating system.

Also, a mail server may contain, communicate, generate, obtain, and/or provide program component, system, user, and/or data communications, requests, information, and/or responses.

Mail Client

A mail client component 1322 is a stored program component that is executed by a CPU 1303. The mail client may be a conventional mail viewing application such as Apple Mail, Microsoft Entourage, Microsoft Outlook, Microsoft Outlook Express, Mozilla Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

Cryptographic Server

A cryptographic server component 1320 is a stored program component that is executed by a CPU 1303, cryptographic processor 1326, cryptographic processor interface 1327, cryptographic processor device 1328, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash function), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the CNM system may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the CNM system component to engage in secure transactions if so desired. The cryptographic component facilitates the secure accessing of resources on the CNM system and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

The CNM System Database

The CNM system database component 1319 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the CNM system database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the CNM system database is implemented as a data-structure, the use of the CNM system database 1319 may be integrated into another component such as the CNM system component 1335. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 1319 includes several tables 1319a-g. Table 1319a includes fields related to data corresponding to the views on criteria (VOC). Table 1319b includes fields related to Selling Status Indicators (SI) 150. Table 1319c includes fields related to Buying/Selling Points 236/247. Table 1319d includes fields related to the Phases of Purchase Process, whereas table 119e includes fields related to key persons identified with a particular customer. Table 1319f includes fields associated with Appropriate Communicators and table 1319g includes fields associated with Networked Resources (e.g., professional contacts).

In one embodiment, the CNM system database may interact with other database systems. For example, employing a distributed database system, queries and data access by CNM system component may treat the combination of the CNM system database, an integrated data security layer database as a single database entity.

In one embodiment, user programs may contain various user interface primitives, which may serve to update the CNM system. Also, various accounts may require custom database tables depending upon the environments and the types of clients the CNM system may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 1319a-e. The CNM system may be configured to keep track of various settings, inputs, and parameters via database controllers.

The CNM system database may communicate to and/or with other components in a component collection, including itself, and/or facilities of the like. Most frequently, the CNM system database communicates with the CNM system component, other program components, and/or the like. The database may contain, retain, and provide information regarding other nodes and data.

The CNM System

The CNM system component 1335 is a stored program component that is executed by a CPU. The CNM system affects accessing, obtaining and the provision of information, services, transactions, and/or the like across various communications networks.

The CNM system component enables and provides a straightforward, unified, and transparent interface that automatically presents system users with an intuitive interface with a Customer Needs Management solution enabling the functionality described above.

The CNM system component enabling access of information between nodes may be developed by employing standard development tools such as, but not limited to: (ANSI) (Objective-) C (++), Apache components, binary executables, database adapters, Java, JavaScript, mapping tools, procedural and object oriented development tools, PERL, Python, shell scripts, SQL commands, web application server extensions, WebObjects, and/or the like. In one embodiment, the CNM system server employs a cryptographic server to encrypt and decrypt communications. The CNM system component may communicate to and/or with other components in a component collection, including itself, and/or facilities of the like. Most frequently, the CNM system component communicates with the CNM system database, operating systems, other program components, and/or the like. The CNM system may contain, communicate, generate, obtain, and/or provide program component, system, user, and/or data communications, requests, and/or responses.

Distributed CNM System

The structure and/or operation of any of the CNM system node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the CNM system controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), process pipes, shared files, and/or the like. Messages sent between discrete component components for inter-application communication or within memory spaces of a singular component for intra-application communication may be facilitated through the creation and parsing of a grammar. A grammar may be developed by using standard development tools such as lex, yacc, XML, and/or the like, which allow for grammar generation and parsing functionality, which in turn may form the basis of communication messages within and between components. Again, the configuration will depend upon the context of system deployment.

The entirety of this disclosure (including the Cover Page, Title, Headings, Field, Background, Summary, Brief Description of the Drawings, Detailed Description, Claims, Abstract, Figures, and otherwise) shows by way of illustration various embodiments in which the claimed inventions may be practiced. The advantages and features of the disclosure are of a representative sample of embodiments only, and are not exhaustive and/or exclusive. They are presented only to assist in understanding and teach the claimed principles. It should be understood that they are not representative of all claimed inventions. As such, certain aspects of the disclosure have not been discussed herein. That alternate embodiments may not have been presented for a specific portion of the invention or that further undescribed alternate embodiments may be available for a portion is not to be considered a disclaimer of those alternate embodiments. It will be appreciated that many of those undescribed embodiments incorporate the same principles of the invention and others are equivalent. Thus, it is to be understood that other embodiments may be utilized and functional, logical, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the invention, and inapplicable to others. In addition, the disclosure includes other inventions not presently claimed. Applicant reserves all rights in those presently unclaimed inventions including the right to claim such inventions, file additional applications, continuations, continuations in part, divisions, and/or the like thereof. As such, it should be understood that advantages, embodiments, examples, functional, features, logical, organizational, structural, topological, and/or other aspects of the disclosure are not to be considered limitations on the disclosure as defined by the claims or limitations on equivalents to the claims.

What is claimed is:

1. A sales management system comprising:
a sales management system customer resource database;
a system user interface configured to receive system user customer impression data and populate the system customer resource database with the system user customer impression data;
a predictive customer data determination module configured to analyze customer impression data and determine predictive customer data, wherein the analysis is conducted based on customer impression data including system user impression data, a customer confidence indicator, transaction specific data and customer specific historical dealing data; and
a predictive customer data access module configured to provide the determined predictive data to a system user.

2. The sales management system of claim 1, wherein the predictive customer data module analyzes the customer impression data, which includes a customer attitude indicator, a relating status indicator, views on criteria, buying points and selling points, data related to the phases of the purchase process, and data related to characteristics associated with at least one key person corresponding to a particular customer.

3. The sales management system of claim 2, wherein the predictive customer data module analysis includes a translation of a system user's customer attitude indicator valuation to derive a customer's confidence indicator.

4. The sales management system of claim 2, wherein the predictive customer data module is configured to facilitate a system user designing a sales event that includes at least buying and selling points for the at least one customer key person.

5. The sales management system of claim 4, wherein the predictive data module is configured to facilitate development of an action plan and related cost estimates.

6. The sales management system of claim 5, further comprising:
a sales event evaluation module configured to facilitate a sales event assessment analysis.

7. The sales management system of claim 6, wherein the sales event evaluation module is configured so that a system user can store data describing the sales interaction with the customer related to the results of the designed sales event.

8. The sales management system of claim 7, wherein the sales event evaluation module is configured so that a system user can evaluate the success of a sales event.

9. The sales management system of claim 8, further comprising:
a sales forecasting module configured to facilitate system user research for a particular customer based on a customer's sales events.

10. A predictive sales management system comprising:
a sales management system customer resource database;
a system user interface configured to provide access to a predictive customer sales data research module, wherein a system user can access historical customer data, as well as predictive customer sales data;
the system user interface is also configured to provide access to a customer data aggregation module that is utilized within the system to input and analyze system user customer impression data;
a predictive salesperson performance module configured to analyze salesperson performance parameters;
a predictive customer data module configured to analyze the customer impression data and derive predictive customer sales data; and
a sales forecasting module configured to determine sales forecasts based on system user customer impression data.

11. The sales management system of claim 10, wherein the system user interacts with the system to memorialize customer impression data as the attitudes and behavior of customers related to a sales event.

12. The sales management system of claim 11, further comprising:
a sales event evaluation module configured to analyze sales events individually or sequentially during a sales forecasting process or a salesperson performance analysis.

13. A predictive sales management system comprising:
a predictive customer sales database configured to provide predictive data based on customer characteristics including data associated with a system user's customer interaction, as well as historical customer transaction data;
a system user interface that facilitates interaction with the predictive customer sales database enabling a system user to develop and implement a customer needs management strategy; and
a predictive customer sales module is configured to facilitate development of the customer needs management strategy based on at least data derived from a phases of purchase process analysis.

14. The predictive sales management system of claim 13, wherein the predictive customer sales module is configured to facilitate development of the customer needs management strategy based on at least data derived from a views on criteria analysis.

15. The predictive sales management system of claim 14, wherein the customer needs management strategy is based on at least data derived from an analysis of system derived customer selling status indicators.

16. The predictive sales management system of claim 15, wherein the system user interface may be configured to facilitate updating both historical and current system user impression data associated with a particular customer.

17. The predictive sales management system of claim 16, wherein the predictive customer sales database includes at least one CNM template within a CNM pattern library.

18. The predictive sales management system of claim 17, wherein the system user creates a sales event for determining a customer sales strategy for a particular potential sale.

19. The predictive sales management system of claim 18, wherein the system user develops at least one buying point and at least one selling point as part of developing the sales event.

20. A customer needs management method comprising:
implementing a sales management system customer resource database;
interacting with a system user interface configured to receive system user customer impression data and populate the system customer resource database with the system user customer impression data;
analyzing customer impression data and determining predictive customer data within a predictive customer data determination module, wherein the analysis is conducted based on customer impression data including system user impression data, a customer confidence indicator, transaction specific data and customer specific historical dealing data; and
providing a system user with access to the resulting determined predictive data.

21. A predictive sales management method comprising:
aggregating customer data within a predictive customer sales database configured to provide predictive data based on customer characteristics including data associated with a system user's customer interaction, as well as historical customer transaction data;
facilitating interaction between a system user and the predictive customer sales database, wherein the system user develops and implements a customer needs management strategy; and
developing the customer needs management strategy based on at least data derived from a phases of purchase process analysis within a predictive customer sales module of a customer needs management system.
